(19) United States
(12) Patent Application Publication
(10) Pub. No.: US 2020/0051039 A1
(43) Pub. Date: Feb. 13, 2020

(54) SYSTEM AND METHOD FOR A DISTRIBUTED LEDGER FOR INDUSTRIAL ASSET MANAGEMENT

(71) Applicant: Walmart Apollo, LLC, Bentonville, AR (US)

(72) Inventors: Joseph JURICH, Molino, FL (US); Chris M. JOHNSON, Bella Vista, AR (US); Todd MATTINGLY, Bentonville, AR (US)

(73) Assignee: Walmart Apollo, LLC, Bentonville, AR (US)

(21) Appl. No.: 16/534,539

(22) Filed: Aug. 7, 2019

Related U.S. Application Data
(60) Provisional application No. 62/715,335, filed on Aug. 7, 2018.

(51) Int. Cl. G06Q 10/00; G06Q 20/36; G06F 16/908; G06F 16/182; G06F 16/18; H04L 9/06

(52) U.S. Cl. CPC G06Q 10/20; G06Q 20/36; G06F 16/908; H04L 2209/38; G06F 16/1805; H04L 9/0637; G06F 16/182

(57) ABSTRACT

Systems, methods, and non-transitory computer-readable storage media for using a distributed ledger to track and manage industrial fixture assets, such as shelves, refrigerators, ovens, and air conditioning units. The distributed ledger is spread among multiple devices and, as devices report new data (such as current and voltage levels), additions to the distributed ledger can be made. The distributed ledger may use blockchain technologies, and each device in the multiple device may have distinct wallets which are used to pay for maintenance requests or other actions.

### PRIORITY

The present disclosure claims priority to U.S. Provisional Application No. 62/715,335, filed Aug. 7, 2018, the contents of which are incorporated herein in their entirety.

### BACKGROUND

### 1. Technical Field

The present disclosure relates to distributed ledgers for industrial asset management, and more specifically to management of a distributed ledger across industrial assets using rotating master-slave relationships, cryptocurrencies, and/or blockchains.

### 2. Introduction

As part of the Internet of Things (IoT), the ability for devices to communicate with one another and with other computing systems continues to increase. For example, users can control smart thermostats, smart lighting, smart speakers, etc., all using smartphones, computers, tablets, or other networked devices. However, while these IoT devices can communicate with one another, such communications lack information which can be used to determine when the IoT devices are beginning to fail or need maintenance. Moreover, tracking this information over time, across facilities, or even across devices as devices are replaced, can result in network and system inefficiencies.

### SUMMARY

Disclosed are systems, methods, and non-transitory computer-readable storage media for using a distributed ledger to track and manage industrial fixture assets. An exemplary method for performing concepts according to this disclosure can include: receiving, at a first device in a plurality of devices connected via a mesh network, metadata associated with a second device in the plurality of devices, wherein each device in the plurality of devices has a primary function which operates independent of a network connection; comparing, via a processor on the first device, the metadata to at least a portion of a distributed ledger, to yield a comparison, the distributed ledger comprising a blockchain, wherein: the first device stores at least the portion of the distributed ledger; an entirety of the distributed ledger is stored across the plurality of devices; the comparing compares the metadata to previously stored first metrics of the first device which were stored in the distributed ledger; and the comparing further compares the metadata to previously stored other metrics of other devices in the plurality of devices which were stored in the distributed ledger; identifying, via the processor and based on the comparison, a distinction in the metadata and at least one of the first metrics and the other metrics stored in the distributed ledger; generating, via the processor and based on the distinction, a modification to the distributed ledger, the modification comprising a new block added to the blockchain; transmitting, to at least one other device in the plurality of devices, the modification; generating, via the processor and based on the distinction, a work order for the first device; initiating, via the processor, payment for the work order using a cryptocurrency wallet associated with the first device.

An exemplary system configured according to this disclosure can include: a processor; and a non-transitory computer-readable storage medium having instructions stored which, when executed by the processor, cause the processor to perform operations comprising: receiving, at a first device in a plurality of devices connected via a mesh network, metadata associated with a second device in the plurality of devices, wherein each device in the plurality of devices has a primary function which operates independent of a network connection; comparing the metadata to at least a portion of a distributed ledger, to yield a comparison, wherein: the first device stores at least the portion of the distributed ledger; an entirety of the distributed ledger is stored across the plurality of devices; the comparing compares the metadata to previously stored first metrics of the first device which were stored in the distributed ledger; and the comparing further compares the metadata to previously stored other metrics of other devices in the plurality of devices which were stored in the distributed ledger; identifying, based on the comparison, a distinction in the metadata and at least one of the first metrics and the other metrics stored in the distributed ledger; generating, based on the distinction, a modification to the distributed ledger; and transmitting, to at least one other device in the plurality of devices, the modification.

An exemplary non-transitory computer-readable storage medium configured according to this disclosure can have instructions stored which, when executed by a computing device, cause the computing device to perform operations which include: receiving, at a first device in a plurality of devices connected via a mesh network, metadata associated with a second device in the plurality of devices, wherein each device in the plurality of devices has a primary function which operates independent of a network connection; comparing the metadata to at least a portion of a distributed ledger, to yield a comparison, wherein: the first device stores at least the portion of the distributed ledger; an entirety of the distributed ledger is stored across the plurality of devices; the comparing compares the metadata to previously stored first metrics of the first device which were stored in the distributed ledger; and the comparing further compares the metadata to previously stored other metrics of other devices in the plurality of devices which were stored in the distributed ledger; identifying, based on the comparison, a distinction in the metadata and at least one of the first metrics and the other metrics stored in the distributed ledger; generating, based on the distinction, a modification to the distributed ledger; and transmitting, to at least one other device in the plurality of devices, the modification.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example of industrial assets communicating using a master-slave relationship;

FIG. 2 illustrates an example of devices communicating using a mesh network;

FIG. 3 illustrates an examples of a master asset being selected;

FIG. 4 illustrates an example of metadata transmission and subsequent modification to the distributed ledger;

FIG. 5 illustrates an example of device maintenance requests being paid for using device specific electronic wallets;

FIG. 6 illustrates an exemplary method embodiment; and

FIG. 7 illustrates an exemplary computer device.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

The present disclosure addresses a distributed ledger system which can be used to track and manage industrial assets using rotating master-slave relationships, cryptocurrencies, and/or blockchains. Exemplary, non-limiting industrial assets can include air conditioning devices, heating devices, refrigeration devices, ovens, shelving, forklifts (and other mobile assets, such as trucks), etc. Each of these devices have a purpose which can be fulfilled without connection to a network (such as the Internet). For example, an air conditioning device has the purpose of cooling air, which does not require a network connection. Likewise, shelving does not require a network connection to fulfill its purpose in holding and storing goods.

However, industrial assets configured according to this disclosure are connected to a network, such as the Internet, or communicate with other industrial assets to form a mesh network. A distributed ledger is maintained among the industrial assets, with information about the various assets being recorded in the distributed ledger. This recording of new data/updating of the distributed ledger can, for example, begin at the asset having data which needs to be added to the ledger. That asset can periodically, or as needed, identify data to be added to the ledger, update the portion of the ledger stored on the asset, then forward the modified/updated ledger to the other industrial assets which share the distributed ledger. For example, every hour information about how much electricity is being consumed by a refrigerator can be added to the distributed ledger which is shared with an oven and an air conditioner. After the refrigerator makes the addition to the portion of the distributed ledger associated with the refrigerator, the refrigerator can forward/transmit the updated portion to the oven, the air conditioner, and any other assets which share the distributed ledger.

In such configurations, each individual asset can be configured to process its respective data and make determinations based on the data. For example, if a processor associated with a shelf compares the weight currently being held on the shelf to a known limit and determines that human assistance is required, the shelf can generate a notification to request human assistance. However, other assets may also be configured to analyze data associated with the shelf and act upon those determinations. For example, the shelf (or more precisely, the processor associated with the shelf) may record the weight being stored on the shelf by updating the distributed ledger, then transmitting the updated distributed ledger to the other assets. One of those other assets which receive the updated distributed ledger may be a microwave, which analyzes the updated distributed ledger, identifies that the weight on the shelf exceeds a threshold value, and generates a notification to humans in the vicinity.

In some combinations, rather than each asset modifying portions of the distributed ledger, then forwarding the modified portion to one or more additional assets, the assets can instead be arranged in a master-slave configuration. In this configuration, certain assets (“masters”) receive data from the assets identified as “slaves.” The master can then determine if the data received from the slave needs to be added to the distributed ledger, and if so can make the addition to the distributed ledger and propagate the update to the appropriate assets. This makes the computer system and network more efficient by reducing network traffic and freeing up the system to handle other task more quickly.

For example, in a retail location there may be a dozen refrigerators used to sell perishable goods. While in some configurations each refrigerator may be configured to add data to the distributed ledger, in other configurations a single refrigerator from the dozen refrigerators may be selected as the master asset. Each remaining refrigerator then transmits data which is specific to the transmitting refrigerator to the master asset, such as current pulled, average temperature, number of door openings, duration of door openings, shelf space available, and/or metadata (data which describes other data). In the cases of periodic transmission, the master refrigerator can then determine if the data received is of sufficient importance to add the data to the distributed ledger. However, in some cases, the refrigerators do not transmit data unless the information meets a threshold level of importance indicating the data needs to be acted upon or needs to be recorded, and in those cases the master asset would immediately take actions based on the reception of the other asset's data.

In some configurations, selection of the master asset from among various assets can be based on the type of assets available, the processing capacity of those assets, the location of the asset, and/or the connection bandwidth the master asset has to the network (or an access point for the network). This selection can be based on those factors increasing the speed and/or efficiency in transmitting updated ledgers to the other assets and/or the speed in communicating with other facets of the network. If one or more of those factors change, the asset identified as the master asset may change. For example, in a group of assets including an oven, a microwave, a refrigerator, and a water filter, the microwave may have the best communication capacity for communicating with the other three assets, and the microwave is therefore made the master node for the group. However, when the microwave is moved it may lose that communication superiority, at which time the group of assets may select a distinct asset to be the master asset.

In some configurations, the individual assets or a master asset can relay the data received to a central computing system (such as a server) which analyzes the data and generates alerts based on the data received from the various asserts. That is, depending on the configuration, the analysis of asset behavior can be done by the asset itself, another asset within a group of assets, a master asset, or other device such as a server. In the case of a server, if an oven begins to draw current significantly higher (above a threshold amount) than other ovens in a group of ovens, or more current than previously drawn by that asset, the server may generate a maintenance request (or even trigger an end-of-life determination) for the oven. Determining how much current was previously drawn by a given unit, or the average current drawn by other units, can be determined by accessing the distributed ledger. In the case of the server, the server may have a distinct database storing the data in conjunction with the distributed ledger.

When units need to be replaced, due to the distributed ledger being partitioned across multiple assets, with every piece of data being duplicated across multiple locations, the replacement asset can receive the portion of the data which was previously stored on the replaced asset. Using the allocated data, the system can determine if the replacement asset is functioning in an improved manner compared to the replaced asset, become integrated into the group of assets, as well as identify future problems for the individual asset.

The form of the distributed ledger can vary between configurations. For example, in some configurations, encryption or data security may be critical and therefore used to protect the data transmissions/storage. In other configurations, the need to verify the source of the data or the veracity of transactions may be paramount, in which case a blockchain can be part of the distributed ledger. Specifically, the blockchain can be used to contain new pieces of data/metadata in new blocks being added to an existing blockchain, and these new blocks can be created upon determining that certain predefined conditions have been met. The new block can then be transmitted/communicated to the other assets in the group for verification of the block's veracity. The other assets in the group of assets can verify the new block based on encryption, identifications, etc., included in the block. Upon verification, the new block can be added to the blockchain, and the updated distributed ledger (which includes the updated blockchain) can be distributed amongst the group.

Requests, notifications, additions to the distributed ledger blockchain, etc., can all require a payment associated with the asset producing the data. Such actions can vary in cost based on what is required. In some cases this can be a payment using a fictional “allowance” of credits or other metric, thereby allowing the system to track the frequency and/or levels of actions being taken by the assets. In other cases, the payment can be a literal payment, requiring a payment in a currency such as the U.S. dollar, the European Euro, etc. The payment may also be made using various cryptocurrencies, such as Bitcoin or Ethereum. In either case, each asset may have an individualized account or wallet linked to the remaining amount of available currency/cryptocurrency available for the asset to make requests. When the amount of funds in the account or wallet reach a threshold amount (such as when the funds are running low), a notification can be generated indicating that the asset needs more funds allocated to it. In some cases, however, the notification may indicate that the asset has used all of its allocated funds and is due to be replaced.

As time progresses, the system can iteratively improve based on past data. This machine learning process takes specific data associated with the assets, compares that data to the frequency of the actions taken, and makes modifications to the processes performed by the assets based on that comparison. For example, if the system determines that a certain class of asset, or an asset at a specific geographic location, provides the best communication efficiency for the system (based on the data rates, bit-error rates, bandwidth, etc.), the system can defer repeated testing to identify a master asset, instead selecting the master asset based on previously identified parameters (and reducing the frequency of verifying that decision as the most efficient). As another example, the system can compare the data associated with various sensors (such as current or voltage levels), and based on specific values determine likelihoods of component failure within the respective assets. While generating notifications for humans the system can then include those likelihoods. Alternatively, if the system has identified a modification which reduces the likelihood of the particular component failure indicated by asset data, the system can automatically initiate that modification.

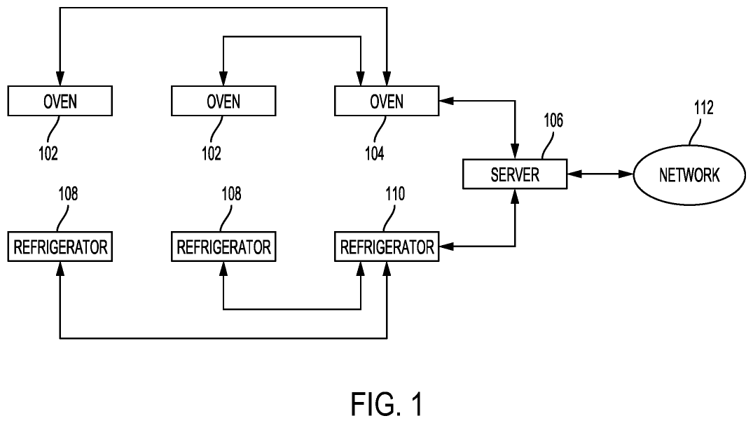

FIG. 1 illustrates an example of industrial assets communicating using a master-slave relationship. As illustrated, there is a group of industrial assets made up of ovens 102, 104, and refrigerators 108, 110. Data from these assets 102, 104, 108, 110 is transmitted to a server 106 connected to a network 112. In some configurations, the communications between the server 106 and the assets 102, 104, 108, 110 may traverse the network 112. In this example, analyses on the data received from the assets 102, 104, 108, 110 are performed at the server 106, which in turn can generate instructions which are transmitted back to the various devices. In addition, the server 106 may generate notifications, requests for help, or other similar responses to the analyses. These notifications and/or requests can be transmitted from the server 106 to the various assets 102, 104, 108, 110 to be included as part of a distributed ledger shared by the assets 102, 104, 108, 110.

In this configuration, the assets 102, 104, 108, 110 do not each individually communicate with the server 106. Instead, the assets 102, 104, 108, 110 are arranged in a master-slave configuration. For example, some ovens 102 are selected to be slaves while another oven 104 is selected as a master. Likewise, refrigerators 108 are slaves while another refrigerator 110 is selected as a master. In this example, assets 102, 104, 108, 110 are divided into slaves and masters based on their device types (ovens, refrigerators). In other configurations, masters and slaves can be based on location, processing capacity, bandwidth, as well as device type. Applied to this example, such a configuration could allow a refrigerator to be a master over an oven, and vice-versa.

The master assets 104, 110 receive communications from the respective slave assets 102, 108, and can then relay those communications to the server 106. Selection of the master assets 104, 110 and assignment of the slave assets 102, 108 can be based on overall network efficiency, locations, signal attenuation, processing capacity, available bandwidth, battery power levels, etc., and can be modified over time as conditions change. For example, the oven master 104 may be removed or turned off, at which point the system determines that the refrigerator master 110 should be master over the remaining oven units 102 (rather than promoting one of the remaining oven units 102 to master). This determination may be based on the refrigerator master 110 having more capacity for receiving or transmitting communications from the slave assets 102, 108, higher bandwidth in communications with the server 106, etc. Thus, as exceptions occur, such as channel degradation, the communication point may be moved to a different asset.

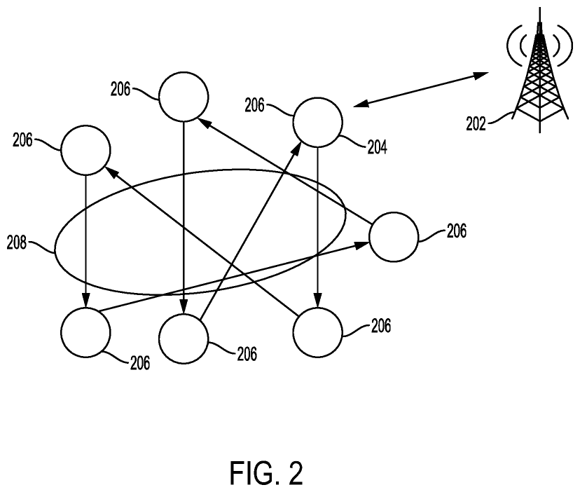

FIG. 2 illustrates an example of devices communicating using a mesh network 208. In this example, the mesh network 208 is formed between multiple devices 204, 206 or assets sharing data between one another. While the mesh network 208 is formed between devices without requiring access to additional networks, preferably at least one of the assets 204 would have the capacity to communicate with a network access point 202, such as a router, cellular tower, Ethernet port, etc. A mesh network 208 allows devices 204, 206 to communicate information between assets 204, 206 directly, without requiring routing using additional switches or routers (although some configurations may use such equipment). In addition, a mesh network 208 allows the devices 204, 206 to perform analyses on their respective data as needed, as well as to partition information (such as a distributed ledger) between the assets 204, 206 as needed.

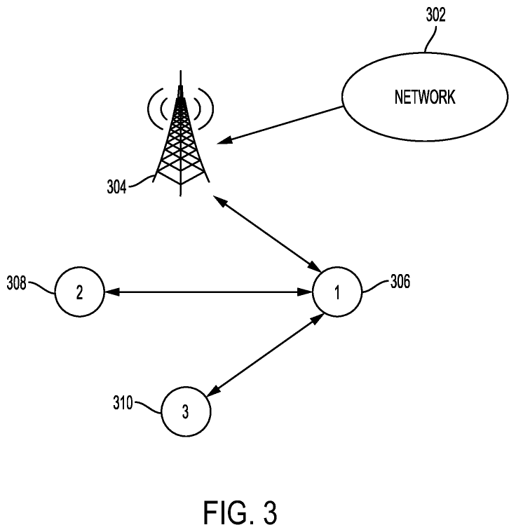

FIG. 3 illustrates an example of a master asset 306 being selected. In this example, a group of assets 306, 308, 310 is in communications with a network 302 via an access point 304. However, rather than each asset 306, 308, 310 communicating directly with the access point 304, a master asset 306 is selected based on the network efficiency, processing capacity, available bandwidth, power drawn, etc., among the assets 306, 308, 310. Over time, if a distinct asset 308, 310 yields increased network efficiency, processing capacity, available bandwidth, power drawn, etc., then that distinct asset 308, 310 can become the master asset, meaning that the new master asset will communicate with the access point 304 and asset 306 will communicate with the new master asset.

In an example, a number of assets 306, 308, 310 are in communication with the access point 304. The communication may take place over one or connections with the access point 304 for each asset 306, 308, 310. Various physical parameters that reflect the strength or throughput of the connection are determined. The assets 306, 308, 310 determine which of the assets should be the connection point to the access point. The authority to make this determination and/or to use one of the assets as the connection may be set forth in a smart contract implemented on blockchain. The smart contract may set forth the terms of determination and the authority for the selected asset to act on behalf of the other assets. The determination of the asset (node) to make the connection to the access point may be adaptive and based on physical data regarding signal strength, upload and download speeds, and other physical parameters.

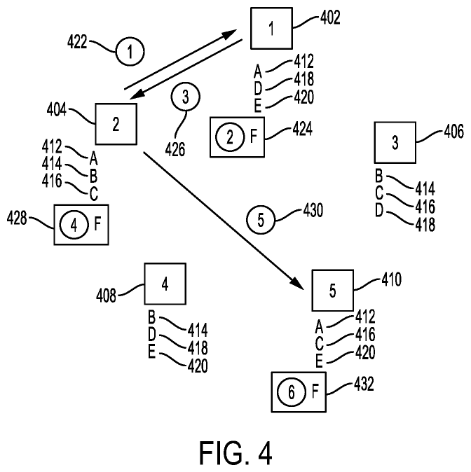

FIG. 4 illustrates an example of metadata transmission and subsequent modification to the distributed ledger. In this example, there are five assets: “1” 402, “2” 404, “3” 406, “4” 408, and “5” 410. These assets 402-410 are storing a distributed ledger having at least which initially has five parts: “A” 412, “B” 414, “C” 416, “D” 418, and “E”420. To ensure that the entirety of the distributed ledger can be reconstructed if any single asset were to fail, each portion 412-420 of the distributed ledger is stored in at least two assets 402-410. For example, part “A” 412 of the distributed ledger is stored in assets “1” 402, “2” 404, and “5” 410.

In this example, asset “2” 404 transmits 422 data (or metadata) to asset “1” 402. Asset “1” 402 analyzes the data and determines that the newly received data needs to be added to the distributed ledger. In a distributed ledger which uses blockchain, this can require generation of a new block to be added to the blockchain, whereas in non-blockchain ledgers this can require generation of a new portion of the distributed ledger. In this example, asset “1” 402 generates a new portion of data “F” 424, which is then transmitted 426 and distributed as needed to the other assets in the group of assets 402-410. As illustrated, asset “2” 404 receives part “F” 424 from asset “1” 402, then stores “F” 428 in memory specific to asset “2” 404. Asset “2” 404 also forwards 430 part “F” to asset “5” 410, which then also stores part “F” 432.

After the process illustrated in FIG. 4, part “F” is stored by assets “1” 402, “2” 404, and “5” 410. This distribution of data allows for improved operational efficiency in accessing data, as well as improved redundancy of storage location should any single asset be removed or disabled.

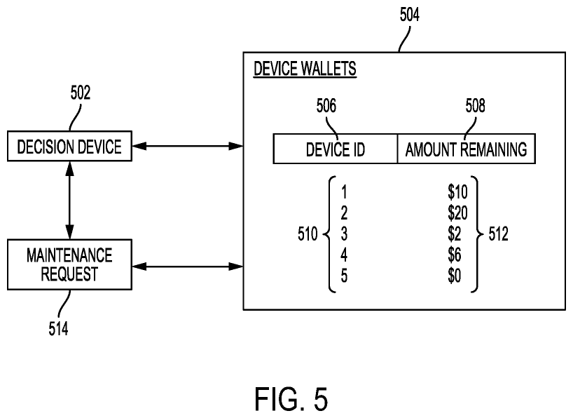

FIG. 5 illustrates an example of device maintenance requests being paid for using device specific electronic wallets. As analyses are performed, the decision making device 502 within a group of assets may determine that a maintenance request 514 should be generated. While in some configurations, the group of assets may share funds or resources for making maintenance requests, in this exemplary configuration each device has an allocated amount of funds/resources to be used for maintenance requests. As the maintenance request is generated or received, a database 504 storing information about the device wallets may be accessed. This database 504 can be part of the distributed ledger stored across the multiple assets, or can be stored externally to the group of assets (for example, on a separate server, on the cloud, etc.). For each asset in the group 510, a device ID (identification) 506 is associated with an amount of funds 508, 512. In some configurations, the decision device 502 can access the information stored in the database 504 when making maintenance decisions, whereas in other configurations the decision device 502 is unaware of the amount remaining in any particular device's funds. In those cases, the decision device 502 may produce a maintenance request, then receive a notification that the associated device does not have sufficient funds for that request. Depending on the maintenance request produced, the decision device 502 may then issue a notification that the associated device needing maintenance should be removed, or that it will likely fail within a predicted time period.

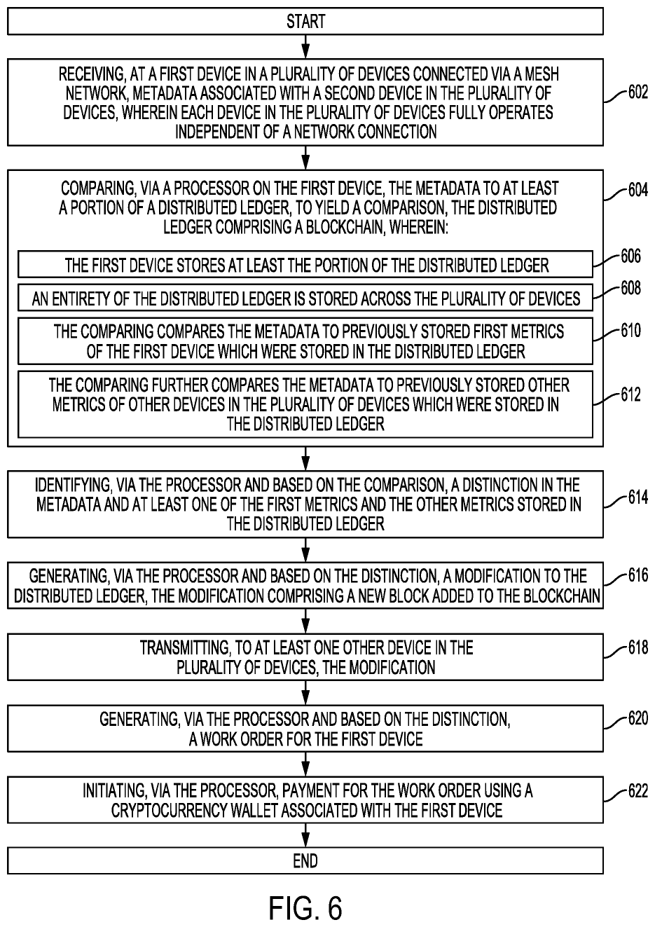

FIG. 6 illustrates an exemplary method embodiment which can be performed by assets and/or systems configured according to this disclosure. In this example, a first device in a plurality of devices connected via a mesh network receives metadata associated with a second device in the plurality of devices, wherein each device in the plurality of devices has a primary function which operates independent of a network connection (602). A processor on the first device compares the metadata to at least a portion of a distributed ledger, to yield a comparison, the distributed ledger comprising a blockchain (604), wherein: the first device stores at least the portion of the distributed ledger (606); an entirety of the distributed ledger is stored across the plurality of devices (608); the comparing compares the metadata to previously stored first metrics of the first device which were stored in the distributed ledger (610); and the comparing further compares the metadata to previously stored other metrics of other devices in the plurality of devices which were stored in the distributed ledger (612).

The first device then identifies, via the processor and based on the comparison, a distinction in the metadata and at least one of the first metrics and the other metrics stored in the distributed ledger (614). The first device generates, via the processor and based on the distinction, a modification to the distributed ledger, the modification comprising a new block added to the blockchain (616), and transmits, to at least one other device in the plurality of devices, the modification (618). The first device then generates, via the processor and based on the distinction, a work order for the first device (620) and initiates, via the processor, payment for the work order using a cryptocurrency wallet associated with the first device (622).

In some configurations, the first device can be selected from among the plurality of devices to receive the metadata and perform operations based on a higher relative throughput of data than other devices in the plurality of devices, the other devices including the second device. The higher relative throughput of data can include transmitting and receiving data associated with the distributed ledger to at least one of a central computer and a network access point and/or transmitting and receiving data associated with the distributed ledger to the other devices in the plurality of devices.

In some configurations, the primary function of each respective device in the plurality of devices comprises one of refrigeration, cooling, cooking, storage, movement of goods, transportation, and heat.

Non-limiting examples of the metadata can include sensor data from a sensor in the second device, the sensor data comprising one of voltage data of the second device, current data of the second device, efficiency of the second device in performing the primary function, and efficiency of the second device in communications with the plurality of devices.

In some configurations, the new block can be verified as valid by other devices in the plurality of devices.

In some configurations, the metadata may be received on a periodic basis.

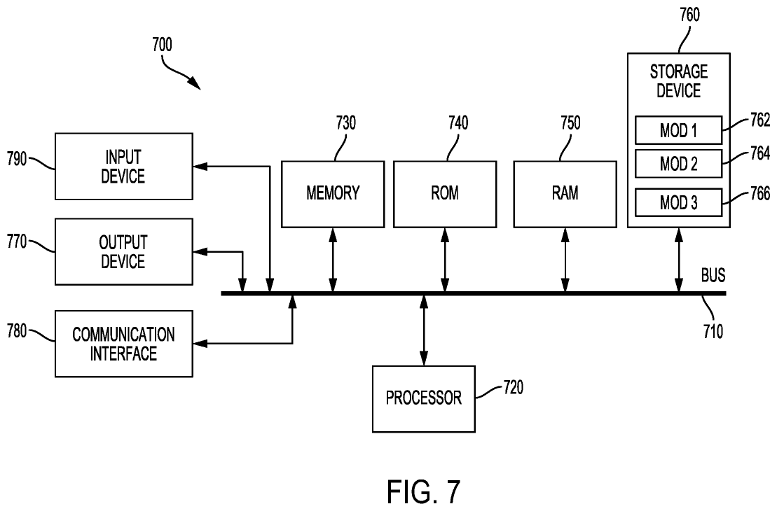

With reference to FIG. 7, an exemplary system includes a general-purpose computing device 100, including a processing unit (CPU or processor) 720 and a system bus 710 that couples various system components including the system memory 730 such as read-only memory (ROM) 740 and random access memory (RAM) 750 to the processor 720. The system 700 can include a cache of high-speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read-only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

The steps outlined herein are exemplary and can be implemented in any combination thereof, including combinations that exclude, add, or modify certain steps. In addition, the examples and configurations described may be combined as necessary provided.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
a. receiving, at a first device in a plurality of devices connected via a mesh network, metadata associated with a second device in the plurality of devices, wherein each device in the plurality of devices has a primary function which operates independent of a network connection;
b. comparing, via a processor on the first device, the metadata to at least a portion of a distributed ledger, to yield a comparison, the distributed ledger comprising a blockchain, wherein:
i. the first device stores at least the portion of the distributed ledger;
ii. an entirety of the distributed ledger is stored across the plurality of devices;
iii. the comparing compares the metadata to previously stored first metrics of the first device which were stored in the distributed ledger; and
iv. the comparing further compares the metadata to previously stored other metrics of other devices in the plurality of devices which were stored in the distributed ledger;
c. identifying, via the processor and based on the comparison, a distinction in the metadata and at least one of the first metrics and the other metrics stored in the distributed ledger;
d. generating, via the processor and based on the distinction, a modification to the distributed ledger, the modification comprising a new block added to the blockchain;
e. transmitting, to at least one other device in the plurality of devices, the modification;
f. generating, via the processor and based on the distinction, a work order for the first device;
g. initiating via the processor, payment for the work order using a cryptocurrency wallet associated with the first device.

2. The method of claim 1, wherein the first device is selected from among the plurality of devices to receive the metadata and perform operations based on a higher relative throughput of data than other devices in the plurality of devices, the other devices including the second device.

3. The method of claim 2, wherein the higher relative throughput of data comprises transmitting and receiving data associated with the distributed ledger to at least one of a central computer and a network access point.

4. The method of claim 2, wherein the higher relative throughput of data comprises transmitting and receiving data associated with the distributed ledger to the other devices in the plurality of devices.

5. The method of claim 1, wherein the primary function of each respective device in the plurality of devices comprises one of refrigeration, cooling, cooking, storage, movement of goods, transportation, and heat.

6. The method of claim 1, wherein the metadata comprises sensor data from a sensor in the second device, the sensor data comprising one of voltage data of the second device, current data of the second device, efficiency of the second device in performing the primary function, and efficiency of the second device in communications with the plurality of devices.

7. The method of claim 1, wherein the new block is verified as valid by other devices in the plurality of devices.

8. The method of claim 1, wherein the metadata is received on a periodic basis.

9. A system comprising:
a. a processor; and
b. a non-transitory computer-readable storage medium having instructions stored which, when executed by the processor, cause the processor to perform operations comprising:
i. receiving, at a first device in a plurality of devices connected via a mesh network, metadata associated with a second device in the plurality of devices, wherein each device in the plurality of devices has a primary function which operates independent of a network connection;
ii. comparing the metadata to at least a portion of a distributed ledger, to yield a comparison, wherein:
1. the first device stores at least the portion of the distributed ledger;
2. an entirety of the distributed ledger is stored across the plurality of devices;
3. the comparing compares the metadata to previously stored first metrics of the first device which were stored in the distributed ledger; and
4. the comparing further compares the metadata to previously stored other metrics of other devices in the plurality of devices which were stored in the distributed ledger;
iii. identifying, based on the comparison, a distinction in the metadata and at least one of the first metrics and the other metrics stored in the distributed ledger;
iv. generating, based on the distinction, a modification to the distributed ledger; and
v. transmitting, to at least one other device in the plurality of devices, the modification.

10. The system of claim 9, wherein the first device is selected from among the plurality of devices to receive the metadata and perform operations based on a higher relative throughput of data than other devices in the plurality of devices, the other devices including the second device.

11. The system of claim 10, wherein the higher relative throughput of data comprises transmitting and receiving data associated with the distributed ledger to at least one of a central computer and a network access point.

12. The system of claim 10, wherein the higher relative throughput of data comprises transmitting and receiving data associated with the distributed ledger to the other devices in the plurality of devices.

13. The system of claim 9, wherein the primary function of each respective device in the plurality of devices comprises one of refrigeration, cooling, cooking, storage, movement of goods, transportation, and heat.

14. The system of claim 9, wherein the metadata comprises sensor data from a sensor in the second device, the sensor data comprising one of voltage data of the second device, current data of the second device, efficiency of the second device in performing the primary function, and efficiency of the second device in communications with the plurality of devices.

15. The system of claim 9, wherein the metadata is received on a periodic basis.

16. A non-transitory computer-readable storage medium having instructions stored which, when executed by a computing device, causes the computing device to perform operations comprising:
a. receiving, at a first device in a plurality of devices connected via a mesh network, metadata associated with a second device in the plurality of devices, wherein each device in the plurality of devices has a primary function which operates independent of a network connection;
b. comparing the metadata to at least a portion of a distributed ledger, to yield a comparison, wherein:
i. the first device stores at least the portion of the distributed ledger;
ii. an entirety of the distributed ledger is stored across the plurality of devices;
iii. the comparing compares the metadata to previously stored first metrics of the first device which were stored in the distributed ledger; and
iv. the comparing further compares the metadata to previously stored other metrics of other devices in the plurality of devices which were stored in the distributed ledger;
c. identifying, based on the comparison, a distinction in the metadata and at least one of the first metrics and the other metrics stored in the distributed ledger;
d. generating, based on the distinction, a modification to the distributed ledger; and
e. transmitting, to at least one other device in the plurality of devices, the modification.

17. The non-transitory computer-readable storage medium of claim 16, wherein the first device is selected from among the plurality of devices to receive the metadata and perform operations based on a higher relative throughput of data than other devices in the plurality of devices, the other devices including the second device.

18. The non-transitory computer-readable storage medium of claim 17, wherein the higher relative throughput of data comprises transmitting and receiving data associated with the distributed ledger to at least one of a central computer and a network access point.

19. The non-transitory computer-readable storage medium of claim 17, wherein the higher relative throughput of data comprises transmitting and receiving data associated with the distributed ledger to the other devices in the plurality of devices.
